(19) United States
(12) Patent Application Publication
(10) Pub. No.: US 2005/0085375 A1
(43) Pub. Date: Apr. 21, 2005

(54) Method for thermally decoking a zeolite catalyst

(76) Inventors: Hermann Bach, Heiligenroth (DE); Harald Kompel, Neu-Isenburg (DE); Peter Trabold, Darmstadt (DE); Peter Konig, Bad Homburg (DE); Walter Boll, Frankfurt am Main (DE); Henning Buchold, Hanau (DE); Frank Hoper, Halterm au See (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/501,449

(22) PCT Filed: Nov. 29, 2002
(86) PCT No.: PCT/EPO2/13495

(30) Foreign Application Priority Data
Dec. 14, 2001 (DE) 10161665.1

(51) Int. Cl. B01D 53/96

(52) U.S. Cl. 502/56

(57) ABSTRACT

The granular, form-selective zeolite catalyst used as bed in a process of producing lower olefins from a feed mixture of higher olefins must be decoked from time to time. This is effected such that the reactor is rinsed with a nitrogen stream heated to 460 to 500° C. for expelling the hydrocarbons, the reactor is then cooled with a nitrogen stream heated to 420 to <460° C., a nitrogen/air mixture heated to 460 to 500° C. then flows through the reactor until complete decoking, and subsequently the reactor is rinsed with a nitrogen stream heated to 460 to 500° C.

This invention relates to a process and an apparatus for the thermal decoking of a zeolite catalyst used for producing lower olefins, preferably C₂ and C₃ olefins, from a mixture of higher olefins, preferably C₄ to C₈ olefins, or from methanol or from dimethyl ether in a reactor with a bed of granular, form-selective zeolite catalyst on the basis of crystalline, pentasil-type alumosilicates.

EP-B-0448000 describes a process of producing lower olefins from methanol by reacting a reaction mixture containing methanol and/or dimethyl ether vapor and steam in a tubular reactor on an indirectly cooled catalyst on the basis of crystalline, pentasil-type alumosilicates with an Si/Al atomic ratio of at least 10. A similar process is also disclosed by DE-A-19723363.

From DE-A-19648795 there is known a process of producing C₃ and C₄ olefins from a feed mixture containing C₄ to C₇ olefins by reacting this mixture at temperatures of 380 to 700° C. on a granular, form-selective pentasil-type zeolite catalyst accommodated as bed in a container, the atomic ratio Si:Al lying in the range from 10:1 to 200:1. Such zeolite catalyst is also used in the process of producing C₂ and C₃ olefins from feed hydrocarbons, which is described in DE-A-10000889.

As in the conversion of higher olefins into lower olefins coke is deposited on the particles of the zeolite catalyst, the zeolite catalyst must be decoked after about 1000 operating hours. For this purpose it is known to supply steam heated to a temperature of about 500° C. to the reactor. By opening a corresponding valve, air is supplied to the reactor in such an amount that an air/steam ratio of first about 0.1 (weight ratio) is achieved. The deflagration of the coke starts spontaneously and advances through the coked sections. Possibly existing hot spots must be monitored very precisely and, if necessary, the amount of air must be reduced, before the reactor temperature exceeds the maximum admissible value. If no hot spots can be detected and/or the decoking process has stabilized, the air/steam ratio is raised to 0.3 by increasing the amount of air. During the decoking process, the temperature in the reactor is maintained at 500° C. During the decoking process, the amount of air supplied is increased in several steps, the amount of steam as well as the exit temperature from the furnace being kept constant. At the indicated temperature of 500° C. at the outlet of the reactor, a termination of the decoking of the catalyst can be recognized in that there is no more increase of the temperature at the reactor outlet.

The disadvantage of this decoking process consists in that the aluminum component is removed from the zeolite catalyst by the steam and due to the resulting change in the pore structure the effect of the zeolite catalyst is impaired and/or in the extreme case no more effect can be detected.

It is the object of the present invention to develop the above-described process such that the catalytic effect of the zeolite catalyst is fully maintained also after decoking.

This object is solved in that in a preliminary stage the reactor is rinsed with a nitrogen stream heated to an entrance temperature of 460 to 500° C. for expelling hydrocarbons from the zeolite catalyst, the nitrogen stream loaded with hydrocarbons is discharged from the reactor, and by means of a nitrogen stream heated to an entrance temperature of 420 to <460° C. the reactor is cooled correspondingly. In a main stage, a nitrogen/air mixture slowly heated to an entrance temperature of 460 to 500° C. flows through the reactor until the zeolite catalyst is completely decoked. In a succeeding stage, the reactor is then rinsed with a nitrogen stream heated to an entrance temperature of 460 to 500° C. for rinsing out air which is present in the catalyst.

In accordance with the preferred embodiment of the process of the invention, the nitrogen/air mixture can still contain up to 75 vol-%, preferably 40 to 60 vol-% steam.

In the preliminary stage, the catalyst is rinsed with nitrogen for 8 to 16 hours and then cooled with nitrogen for 1 to 8 hours, corresponding to the degree of coke formation. In the main stage, a nitrogen/air mixture heated in several process steps of 5 to 20° C. each in a period of 0.5 to 1.0 hours each flows through the reactor, and the entrance temperature of the nitrogen/air mixture per process step is kept constant for 6 to 16 hours, preferably for 8 to 12 hours, and if necessary for up to 24 hours.

The amount of air in the nitrogen/air mixture is 2 to 10 vol-% and with proceeding decoking is increased to 50 vol-%, at least in the last process step.

The rinsing nitrogen stream loaded with hydrocarbons, which leaves the reactor, is supplied to a thermal treatment, while the nitrogen stream used for cooling, which is discharged from the reactor, is either released to the atmosphere or recirculated to the process cycle. The larger amount of the nitrogen/air mixture leaving the reactor is recirculated to the reactor and only the smaller amount is released to the atmosphere.

The apparatus for performing the process comprises a heater used for heating the nitrogen streams and/or the nitrogen/air stream, a succeeding reactor, a succeeding dust separator, a succeeding air cooler, and a succeeding compressor.

A particular aspect of the apparatus is to be seen in that a heat exchanger is disposed before the heater, through which heat exchanger flows the dust-laden nitrogen/air mixture leaving the reactor before entering the dust separator.

The invention will subsequently be explained in detail with reference to the process flow diagram represented in FIG. 1 and an embodiment.

In the production of ethylene or propylene in ethylene plants, C₄ or C₅ olefins are obtained in larger amounts as byproducts. These olefins can be converted into C₂ and C₃ olefins by an adiabatic reaction in the gas phase on a zeolite catalyst (2) on the basis of crystalline, pentasil-type alumosilicates, which catalyst is incorporated as bed in the lying reactor (1). We know from experience that such catalyst must be regenerated, i.e. decoked, after about 1000 operating hours, as the catalyst particles are covered with coke. For this purpose, the reactor (1) with the corresponding fittings is disconnected from the other reactors in operation. In accordance with the decoking program, 15.600 m³/h nitrogen are charged to the heat exchanger (4) via line (3) and to the heater (6) via line (5) and in the same heated to a temperature of 480° C. The nitrogen stream leaving the heater (6) via line (7) is supplied to the reactor (1). The nitrogen stream loaded with hydrocarbons is discharged from the reactor (1) and supplied to the heat exchanger (4) via line (8). The nitrogen stream leaving the heat exchanger (4) via line (9) is supplied to the air cooler (12) via the dust separator (10) and then via line (11) and then to the exhaust gas blower (14) via line (13). Via line (15), the nitrogen stream leaving the gas blower is supplied to the flare via line (16). Rinsing the zeolite catalyst takes 12 hours.

Subsequently, the reactor (1) is cooled for 4 hours with a corresponding amount of nitrogen, which has been heated in the heater (6) to an entrance temperature of 440° C. The nitrogen stream leaving the reactor (1) is recirculated to the plant cycle via line (17). For the actual decoking, 5 vol-% air are admixed to the nitrogen via line (18), and the entrance temperature of the nitrogen/air mixture is raised in process steps of 10° until reaching the entrance temperature of 480° C., the entrance temperature being kept constant with each process step for 12 hours. Upon reaching the entrance temperature of 480° C., the air content of the nitrogen/air mixture is first increased to 25% and then to 50% for a period of 12 hours each. Decoking is completed when the increase in temperature above the catalyst bed goes towards 0 and/or when less or no oxygen is consumed in the reactor. In the last process step, the air supply is shut off and the reactor (1) is rinsed with nitrogen for 12 hours, in order to remove the oxygen from the zeolite catalyst and/or from the reactor.

The advantage achieved by means of the invention must be seen in particular in that the effect of the zeolite catalyst is maintained completely by using a nitrogen/air mixture for the purpose of decoking the zeolite catalyst.

1. A process for the thermal decoking of a zeolite catalyst used for producing lower olefins from a mixture of higher olefins or from methanol or from dimethyl ether in a reactor (1) having a bed of granular, form-selective zeolite catalyst (2) comprised of pentasil-type alumosilicates, wherein, in a first step the reactor (1) is rinsed with a nitrogen stream heated to an entrance temperature of 460 to 500° C. to expel the hydrocarbons from the zeolite catalyst, the nitrogen stream, loaded with hydrocarbons, is discharged from the reactor, in a second step a nitrogen stream heated to a temperature of 420 to <460° C. is introduced into and passed through the reactor to cool it to a temperature in the range of 420 to <460° C., in a third step a nitrogen/air mixture is introduced into and passed the reactor, and gradually heated to reach a temperature at the point where it enters the reactor of 460 to 500° C. and continued flowing through the reactor until the zeolite catalyst is completely decoked, and then, in a fourth step, the reactor is rinsed with a nitrogen stream heated to an entrance temperature of 460 to 500° C. to rinse air from the zeolite catalyst.

2. The process as claimed in claim 1, wherein the nitrogen/air mixture contains up to 75 vol.-% steam.

3. The process as claimed in claim 1 or 2, wherein, in said first step, the reactor (1) is rinsed with nitrogen for 8 to 16 hours.

4. The process as claimed in claim 1 or 2, wherein, in said second step, the reactor (1) is cooled with nitrogen for 1 to 8 hours.

5. The process as claimed in claim 1 or 2, wherein, in said third step said nitrogen/air mixture is heated in several process steps of 5 to 20° C. each over a period of 0.5 to 1.0 hours each, and the entrance temperature for each of said process steps is kept constant for up to 24 hours.

6. The process as claimed in claim 1 or 2, wherein the air content of said nitrogen/air mixture of said third step is initially 2 to 10 vol-%, and is raised up to 50 vol-%, at least as the decoking reaches completion.

7. The process as claimed in claim 1 or 2, wherein the nitrogen stream loaded with hydrocarbons, which is discharged from the reactor (1), is supplied to a thermal treatment.

8. The process as claimed in claim 1 or 2, wherein the nitrogen stream used for cooling is discharged from the reactor (1) and is released to the atmosphere or recirculated to the cycle.

9. The process as claimed in claim 1 or 2, wherein the greater amount of the nitrogen/air mixture discharged from the reactor (1) is recirculated to the reactor and the remainder is discharged to the atmosphere.

10. An apparatus for performing the process as claimed in claim 1 or 2, comprising a heater (6) used for heating the nitrogen streams and the nitrogen/air stream, a succeeding reactor (1), a succeeding dust separator (10), a succeeding air cooler (12), and a succeeding compressor (14).

11. The apparatus as claimed in claim 10, comprising a heat exchanger (4) disposed before the heater (1).

12. The process of claim 1, wherein said lower olefins are C₂ and C₃ olefins and said higher olefins are C₄ to C₈ olefins.

13. The process of claim 2, wherein said amount of steam is 40 to 60 vol. %.

14. The process of claim 5, wherein said entrance temperature is kept constant for 8 to 16 hours.

15. The process of claim 14, wherein said entrance temperature is kept constant for 8 to 12 hours.
